(19) United States
(12) Patent Application Publication
(10) Pub. No.: US 2010/0205474 A1
(43) Pub. Date: Aug. 12, 2010

(54) REDUNDANT, DISTRIBUTED COMPUTER SYSTEM HAVING SERVER FUNCTIONALITIES

(75) Inventors: Christian M. STICH, Leutershausen (DE); Marcel Dix, Mannheim (DE); Mats A. Petterson, Vaesteras (SE)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zurich (CH)

(21) Appl. No.: 12/715,814

(22) Filed: Mar. 2, 2010

Related U.S. Application Data
(63) Continuation of application No. PCT/EP2008/006819, filed on Aug. 20, 2008.

(30) Foreign Application Priority Data
Sep. 3, 2007 (DE) 10 2007 041 651.4

(51) Int. Cl. G06F 11/00

(52) U.S. Cl. 714/1; 714/E11.02

(57) ABSTRACT

A distributed computer system is disclosed which contains at least two physical computers and at least two services installed in the system. The computers function as servers for at least one of the services. To make the system redundant, at least one of the physical computers, in addition to containing the server functionality of a first service, also contains a virtual machine having the server functionality of a second service. A method is also disclosed for implementing redundant server functionalities in a distributed computer system.

### RELATED APPLICATIONS

This application claims priority as a continuation application under 35 U.S.C. §120to PCT/EP2008/006819, which was filed as an International Application on Aug. 20, 2008 designating the U.S., and which claims priority to German Application 10 2007 041 651.4 filed in Germany on Sep. 3, 2007. The entire contents of these applications are hereby incorporated by reference in their entireties.

### FIELD

The disclosure relates to a distributed computer method and a related system having a plurality of physical processing units, each of which can have the functionality of a server for at least one specific service.

### BACKGROUND INFORMATION

Computer servers can have a specific probability of failure dependent, for example, on the wear of the hardware contained therein. The distributed computer system can include further types of computer (e.g., clients), but other computer types are not discussed in greater detail here because exemplary embodiments of the disclosure relate to servers.

To increase the availability of a service provided by a server in each case, the servers can be organized in a redundant manner in a distributed computer system. A known model of a redundant system is illustrated in FIG. 1. In this case, the upper part of the drawing shows a non-redundant starting system, having a number n of servers S₁, S₂, S₃ to Sₙ, each of which is set up for one of n services Dₐ, D_{b}, D_{c} to Dₙ. The lower part of the illustration shows a redundant target system, wherein those servers whose services are implemented redundantly in the system are duplicated in the system. The servers S(ₙ₊₁) to S(ₙ₊ₙ), which are installed in addition to the primary servers S₁ to Sₙ, are set up for the redundantly installed services Dₐ′ to Dₙ′. The redundant services Dₐ′ to Dₙ′ can be logically integrated within such a system (e.g., in accordance with a fail-over model), such that a transition to a corresponding server takes place automatically in the event of a server failure.

In the known redundant computer system, an additional processing unit is installed for each service that is to be implemented redundantly. In the largest case, in which all servers are made redundantly available, this involves a twofold increase in the number of processing units as illustrated in FIG. 1. This not only results in higher procurement costs for hardware, but also in greater demand for space and higher operating costs (e.g., due to high energy costs).

### SUMMARY

A distributed computer system is disclosed which contains at least two physical processing units and at least two services, the system comprising (a) plural physical processing units, each equipped with functionality of a server for at least one of plural services, and (b) at least one physical processing unit containing, in addition to server functionality of a first service, a virtual machine having server functionality of a second service to provide redundancy.

A method is also disclosed for installing redundant server functionalities in a distributed computer system having a first physical processing unit and at least a second physical processing unit, which each contain server functionality of one of at least two services, the method comprising: (a) installing a virtual machine in the second physical processing unit, (b) generating at least one of: a clone of a server functionality of a first of the at least two services for migration, into the virtual machine of the second physical processing unit, and an installation of the server functionality of the first service from scratch in the virtual machine, and (c) integrating the virtual machine formed with the server functionality in the computer system as a first redundant server.

### BRIEF DESCRIPTION OF THE DRAWINGS

A further explanation of the disclosure of exemplary embodiments and their advantages are set forth in the following description of an exemplary embodiment with reference to the drawings, in which:

FIG. 1 shows an embodiment of a known redundant server system;

FIG. 2 shows an exemplary embodiment of a redundant server system as disclosed herein; and

FIG. 3 shows an exemplary comparative illustration of a probability of failure for a service in differently designed server systems.

### DETAILED DESCRIPTION

Exemplary embodiments of the disclosure are directed to a redundant server system which can be realized at modest expense. A distributed computer system as disclosed herein includes redundantly available server functions.

An exemplary distributed computer system as disclosed herein can contain at least two physical processing units. At least one of the processing units can be equipped with the functionality of two servers, wherein one of the two servers is installed in each case as a virtual machine in the processing unit. The two servers of each processing unit thus prepared are set up for two different services. In this context, one of the two services in each case is a service which has been installed redundantly in the computer system. If a redundant server is to be available for all services, a virtual machine can be installed in all processing units.

In order to implement an exemplary embodiment, it is desirable that the physical processing units used for redundant functions be powerful enough in each case to additionally operate a virtual machine.

An exemplary computer system according to the disclosure can have a number of advantages, such as:

By providing redundancy by means of virtual machines, it is possible to achieve a reduction in a probability of failure for installed services, without having to install additional physical processing units. The improved probability of failure thus achieved can be higher in the case of a redundant system as disclosed herein than in the case of known redundant systems as disclosed herein particularly if, for example, no additional physical processing units are to be used.

In order further to reduce a probability of failure, an additional installation of physical processing units is not excluded. As a rule, redundancy is provided for all of the installed services by means of virtual—or additionally also physical—machines, but it is also possible to set up redundancy for only some of the services, depending on the importance of the services. In the case of an exemplary method for installing redundant services in virtual machines, so-called cloning of services can be used. It is understood, however, that a service can alternatively be installed from scratch in a virtual machine.

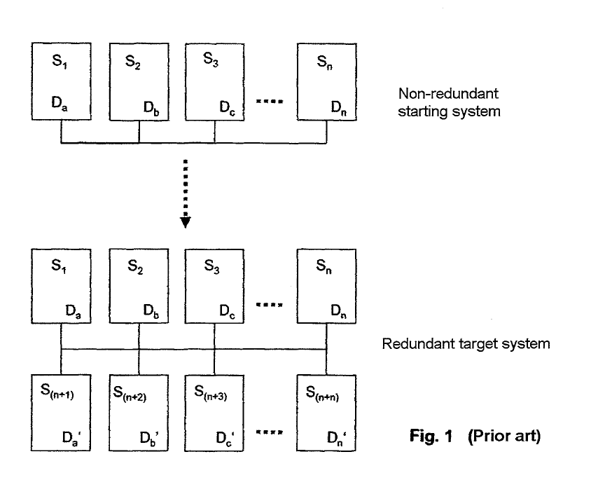

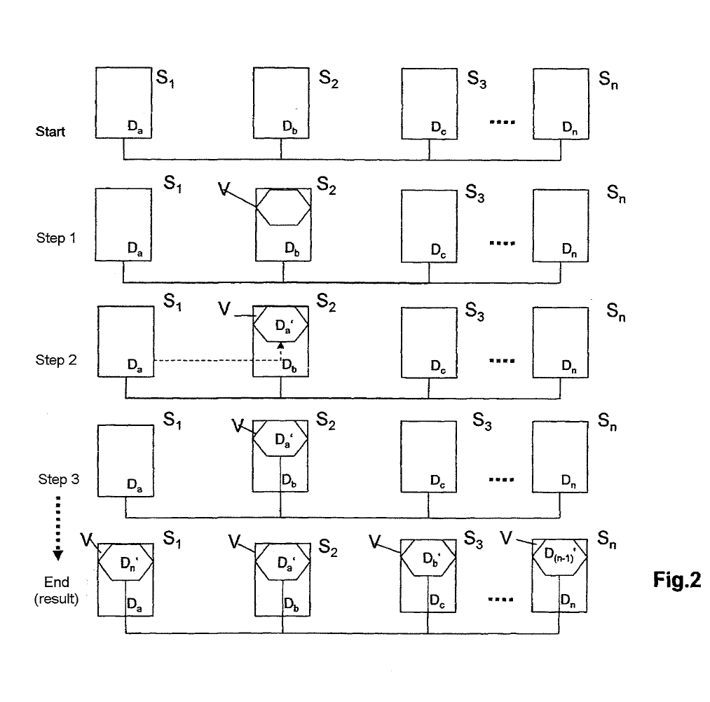

In the upper part of the drawing, FIG. 2 shows a non-redundant starting system which includes servers S₁, S₂, S₃ to Sₙ and corresponds to the illustration in FIG. 1, the servers being set up in each case for one of the services Dₐ, D_{b}, D_{c} to Dₙ. The letter n here also represents the number of servers or services present. At the very bottom, a corresponding system according to the disclosure is shown, in which for the purpose of providing redundancy, the servers S₁, S₂, S₃ to Sₙ, in addition to one of the original services Dₐ, D_{b}, D_{c} to Dₙ in each case, have a virtual machine V in each case with a redundant service installed therein, specifically the services designated as Dₐ′, D_{b}′ to Dₙ′.

Between systems which are illustrated at the top and the bottom of the drawing—the systems having already been explained previously—FIG. 2 also shows three steps in order to explain an exemplary procedure for installing the redundant services.

In order to provide redundancy for the first service Dₐ installed in the first server S₁, for example, in step 1 a virtual machine V is first installed on another server, here the second server S₂.

In step 2, a clone Dₐ′ of the first service Dₐ can be created and migrated into the virtual machine V of the second server S₂. In this context, “cloning” refers to a copy being generated, wherein the copy Dₐ′ has the same functionality as the first service Dₐ. Alternatively, the functionality of Dₐ′ can also be installed from scratch in the virtual machine.

In step 3, the virtual machine V of the second server S₂ can be logically added to the computer system as a redundant server for the service Dₐ (e.g., as a new processing unit with its own identity). In order to ensure that the copy of Dₐ is not simply present twice in the distributed system, but operates like a new processing unit with its own identity as a redundant part of its original, the copy can be configured and adapted accordingly here.

In order to organize all the services Dₐ, D_{b}, D_{c} to Dₙ in a redundant manner, the steps 1 to 3 can be carried out for each service, such that consequently the services Dₐ and Dₙ′ are installed in the first server S₁, the services D_{b} and Dₐ′ are installed in the second server S₂, the services D_{c} and D_{b}′ are installed in the third server S₃, and so on until finally the services Dₙ and D_{(n-1))′}, are installed in the n-th server Sₙ.

In an exemplary embodiment of a redundant system disclosed herein, for each service Dₐ to Dₙ, a redundant server functionality Dₐ′ to Dₙ′, can therefore be installed on a different processing unit S₁ to Sₙ in each case.

Alternatively, however, redundancy can be restricted to specific selected services only.

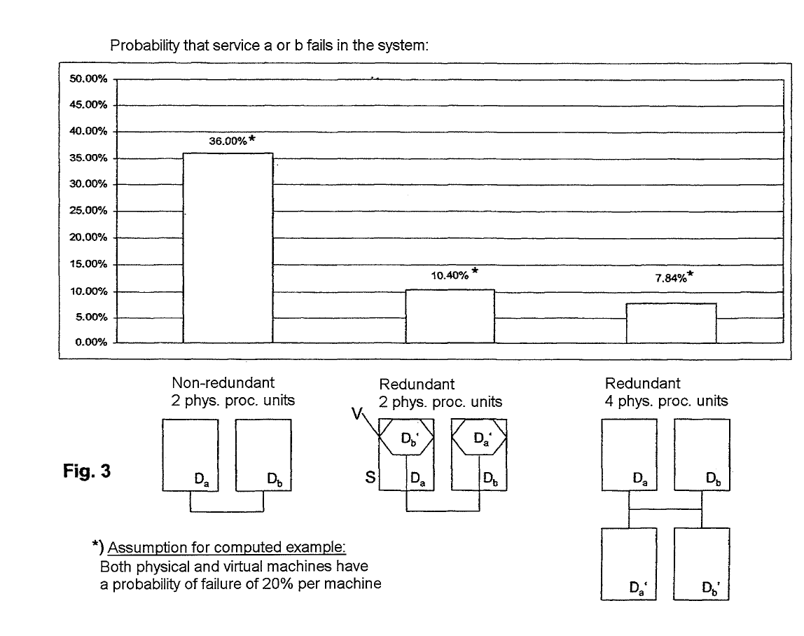

FIG. 3 shows an exemplary illustration of a probability that one of the services installed in a system will fail and that the overall functionality of the distributed system will be adversely affected as a result. In the computed example, three different systems are compared and it is assumed that both physical and virtual machines have a probability of failure of 20% per machine. The comparison relates to, for example:
a non-redundant system containing two physical processing units which respectively have the server function for two primary services Dₐ and D_{b};
a redundant system containing two physical processing units S which each respectively have a server function for two primary services Dₐ and D_{b}, wherein the processing units S respectively contain a virtual machine V with an installed redundant service Dₐ′ and D_{b}′; and
a known redundant system containing four physical processing units which have the server function for two primary services Dₐ and D_{b} and two redundant services Dₐ′ and D_{b}′.

The FIG. 3 illustration shows that the non-redundant system has a calculated probability of failure of 36.00% for one of the services. The corresponding probability of failure is only 7.84% in the case of the known redundant system containing four physical processing units. In the case of an exemplary redundant system as disclosed herein, an exemplary probability of failure of 10.84% is admittedly somewhat higher than in the case of the known redundant system, but can be seen as a good compromise if no additional physical processing units are to be used.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A distributed computer system which contains at least two physical processing units and at least two services, the system comprising:
a) plural physical processing units, each equipped with functionality of a server for at least one of plural services; and
b) at least one physical processing unit containing, in addition to server functionality of a first service, a virtual machine having server functionality of a second service to provide redundancy.

2. The distributed computer system as claimed in claim 1, wherein the at least one physical processing unit containing a virtual machine provides redundant functionality of a second physical server, such that a redundant server functionality is present for at least one service.

3. The distributed computer system as claimed in claim 1, wherein for each of the plural services, a redundant server functionality is installed respectively on another of the plural physical processing units.

4. The distributed computer system as claimed in claim 1, comprising:
at least one additional, and redundant physical processing unit having the server functionality of at least one of the plural services to reduce a probability of failure in the system.

5. A method for installing redundant server functionalities in a distributed computer system having a first physical processing unit and at least a second physical processing unit, which each contain server functionality of one of at least two services, the method comprising:
a) installing a virtual machine in the second physical processing unit;
b) generating at least one of: a clone of a server functionality of a first of the at least two services for migration, into the virtual machine of the second physical processing unit, and an installation of the server functionality of the first service from scratch in the virtual machine; and
c) integrating the virtual machine formed with the server functionality in the computer system as a first redundant server.

6. The method as claimed in claim 5, comprising:
repeating the installing, generating and integrating for remaining server functionalities of further services to provide further redundant servers.
